(19) United States
(12) Patent Application Publication
(10) Pub. No.: US 2024/0316804 A1
(43) Pub. Date: Sep. 26, 2024

(54) A MOUNTING ASSEMBLY

(71) Applicant: KONINKLIJKE PHILIPS N.V., EINDHOVEN (NL)

(72) Inventors: MARCUS CORNELIS PETRELLI, GRONINGEN (NL); ALWIN WILLIAM DE VRIES, ZUIDLAREN (NL); THEODOOR RENÉ MARIA HIN, EMMEN (NL)

(21) Appl. No.: 18/574,443

(22) PCT Filed: Jun. 27, 2022
(86) PCT No.: PCT/EP2022/067468

§ 371 Date: Dec. 27, 2023

(30) Foreign Application Priority Data
Jul. 2, 2021 (EP) 21183454.4

(51) Int. Cl. B26B 19/04

(52) U.S. Cl. CPC B26B 19/048

(57) ABSTRACT

According to an aspect, there is provided a mounting assembly (10) for a hair cutting appliance. The mounting assembly comprises: a head (12) for receiving a cutting unit; a base (14) and a mount. The head is mounted to the base via the mount such that the head is pivotably moveable relative to the base about a primary axis (15) and a secondary axis (30), wherein the primary axis and the secondary axis are not parallel. A first biasing element (34a) and a second biasing element (34b) act independently of one another, wherein the first biasing element and the second biasing element are mounted at a fixed point and configured to act on the head or the mount at a respective first biasing point (40a) and second biasing point (40b) to bias the pivoting movement of the head with respect to the base to a stable position. The first biasing point and the second biasing point are located on the same side of a primary plane (50) which comprises a biasing axis (24a), parallel to the primary axis, about which the first biasing point and the second biasing point are constrained to pivot relative to the fixed point, and a line parallel to a force direction (52) defined by a biasing force applied at one of the first biasing point or the second biasing point, to bias the head in one pivoting direction to the stable position with respect to the base about the primary axis. The first biasing point and the second biasing point are located on opposing sides of a secondary plane (60) which comprises the secondary axis and a line parallel to the force direction, to balance the head in the stable position with respect to the base about the secondary axis.

### FIELD OF THE INVENTION

The invention relates to a mounting assembly for a hair cutting appliance, a hair cutting appliance comprising the mounting assembly, and a biasing unit for the mounting assembly.

### BACKGROUND OF THE INVENTION

Hair cutting appliances typically have a blade head which is pivotable about a first axis to follow the contours of a face. Previously considered hair cutting appliances also allow pivoting movement about a second axis to follow the contours of a face better. However, ensuring enough stiffness in pivoting movement of the head requires a bulky arrangement of springs and contacting parts.

US 2012/0060382 discloses a pivoting arrangement for a shaving device having a pivoting member and a spring loading arrangement to pivot the pivoting member in two pivoting directions.

### SUMMARY OF THE INVENTION

According to a first specific aspect, there is provided a mounting assembly for a hair cutting appliance, the mounting assembly comprising: a head for receiving a cutting unit; a base and a mount, wherein the head is mounted to the base via the mount such that the head is pivotably moveable relative to the base about a primary axis and a secondary axis, wherein the primary axis and the secondary axis are not parallel; and a first biasing element and a second biasing element, wherein the first biasing element and the second biasing element act independently of one another, wherein the first biasing element and the second biasing element are mounted at a fixed point and configured to act on the head or the mount at a respective first biasing point and second biasing point to bias the pivoting movement of the head with respect to the base to a stable position, wherein the first biasing point and the second biasing point are located on the same side of a primary plane which comprises a biasing axis, parallel to the primary axis, about which the first biasing point and the second biasing point are constrained to pivot relative to the fixed point, and a line parallel to a force direction defined by a biasing force applied at one of the first biasing point or the second biasing point, to bias the head in one pivoting direction to the stable position with respect to the base about the primary axis, and wherein the first biasing point and the second biasing point are located on opposing sides of a secondary plane which comprises the secondary axis and a line parallel to the force direction, to balance the head in the stable position with respect to the base about the secondary axis.

The primary axis and the secondary axis may be substantially perpendicular.

The moment arm of the first biasing point from the biasing axis may be the same length as the moment arm of the second biasing point from the biasing axis. In other words, the first biasing point and the second biasing point may lie equidistant from the biasing axis.

The moment arm of the first biasing point from the secondary axis may be the same length as the moment arm of the second biasing point from the secondary axis. In other words, the first biasing point and the second biasing point may lie equidistant from the secondary axis.

The mount may comprise two arms disposed between the base and the head to form a linkage, each arm being coupled at a joint to a respective head coupling on the head, and coupled at a joint to a respective base coupling on the base. Each joint at each head coupling may be configured to permit pivoting movement about respective parallel head pivot axes, such that the head is pivotable relative to the base about one of the primary axis and the secondary axis. The joints at the base couplings may be configured to permit pivoting movement of the arms about at least the other of the primary axis and the secondary axis.

For example, the linkage may be a three-bar linkage in which the head pivot axes of each joint at the head couplings are collinear, and in which the head pivot axis is one of the primary axis or secondary axis.

The joints at the base couplings may further permit pivoting movement about respective base pivot axes which are parallel to the head pivot axes. Each arm may be coupled to a different respective head coupling to permit pivoting movement about different parallel head pivot axes, thereby forming a four-bar linkage, by which the head is pivotably moveable relative to the base about a virtual pivot axis which is one of the primary axis or the secondary axis.

The virtual pivot axis may be the primary axis.

The mounting assembly may comprise a stroke limiter which is configured to obstruct pivoting movement of the head relative to the base beyond a limit. The stroke limiter may be configured to obstruct pivoting movement of the four-bar linkage to thereby inhibit pivoting movement of the head relative to the base about the primary axis beyond the limit. The biasing force at the first biasing point and the second biasing point may have the same moment direction about the biasing axis. The stable position may be the limit.

Each biasing element may be a leaf spring. Each biasing element may be disposed on a single integral biasing unit.

The mounting assembly may comprise a stop for each biasing element which is configured to abut the respective biasing element to limit movement of the biasing element to thereby pretension the biasing element. The stop may be integral with the biasing element.

According to a second aspect, there is provided a hair cutting appliance comprising a mounting assembly according to the first aspect.

According to a third aspect, there is provided a biasing unit for a mounting assembly according to the first aspect, the biasing unit comprising a first biasing element and a second biasing element which act independently of one another, wherein the first biasing element and the second biasing element are each in the form of an integral leaf spring, and wherein the biasing unit comprises a pair of integral stops for each leaf spring, each stop being configured to abut the respective leaf spring to limit movement of the leaf spring to thereby pretension the leaf spring.

These and other aspects will be apparent from and elucidated with reference to the embodiment(s) described hereinafter.

### BRIEF DESCRIPTION OF THE DRAWINGS

Exemplary embodiments will now be described, by way of example only, with reference to the following drawings, in which:

FIG. 1 schematically shows a side view of an example mounting assembly for a hair cutting appliance;

FIG. 2 schematically shows an isometric cutaway view of the mounting assembly; and

FIG. 3 is a diagram showing biasing point locations for the mounting assembly.

### DETAILED DESCRIPTION OF THE EMBODIMENTS

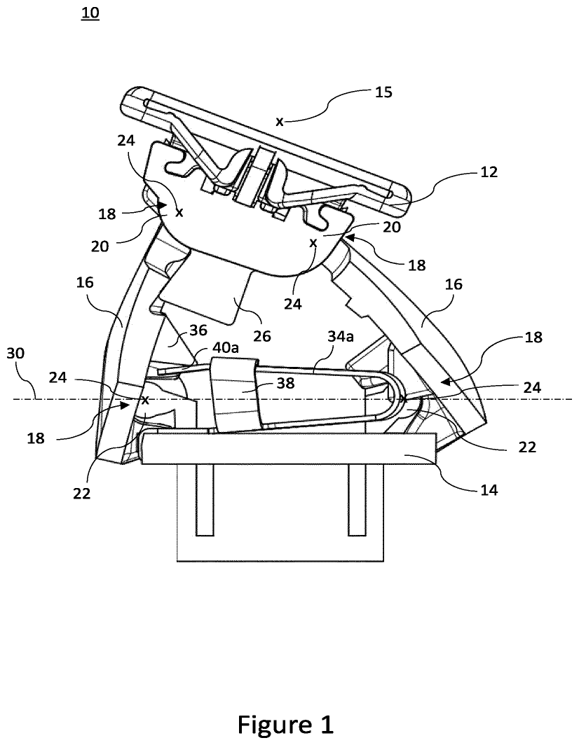

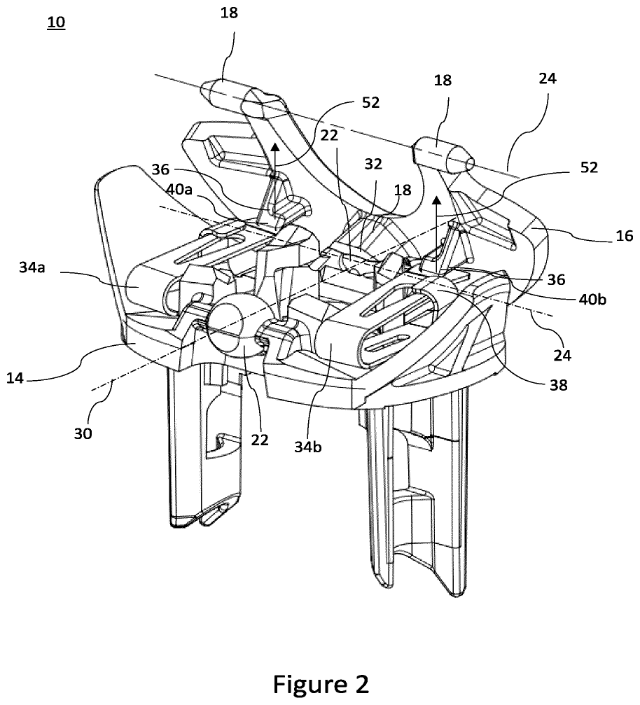

FIG. 1 shows a side view of an example mounting assembly 10 for a hair cutting appliance, and FIG. 2 shows an isometric view of the same mounting assembly 10 with parts removed to demonstrate the inner mechanical working of the mounting assembly 10. A hair cutting appliance may comprise the mounting assembly, and may also comprise a handle and a cutting unit.

The mounting assembly 10 comprises a head 12 (only shown in FIG. 1, the head 12 has been removed in FIG. 2) which is configured to receive a cutting unit, such as a blade or electric trimming attachment, and a base 14 for connection to a handle configured to be held by a user. In some examples, the base may be integral with a handle.

The head 12 is mounted to the base 14 via a mount, which in this example is in the form of a pair of arms 16 (only one arm is shown in FIG. 2). Each arm 16 is connected at a joint 18 to respective head couplings 20 and connected at a joint 18 to respective base couplings 22.

In this example, the arms 16 each comprise two diverging strands in a U-shape such that each arm 16 is connected to the base 14 at a single base coupling 22 at the apex of the U-shape, and such that each arm 16 is connected at the two ends of the U-shape to a respective head coupling 20. Therefore, there are two base couplings 22 on the base 14, and there are four head couplings 20 on the head 12. The head 12 is supported relative to the base 14 by the four head couplings 20 which connect to the arms 16.

In other examples, each arm may comprise a single strand to form an I-shape such that the head is supported by the arms at only two head couplings in total, or the arms may comprise more than two diverging strands so that the coupler link is supported by the arms at more than two coupler joins per arm. Each arm may have a different number of diverging strands to support the coupler link at, for example 3 or 5 coupler joins. In yet further examples, the arms may comprise two diverging strands in the form of a T, V or Y shape such that each arm supports the coupler link at two coupler joins.

Each joint 18 is configured to permit pivoting movement between the respective arms 16, head 12 and base 14, about parallel pivot axes 24 (shown as going into the page on FIG. 1) to form a four-bar linkage in which each arm 16 is one bar, the head 12 is one bar and the base 14 is one bar of the four-bar linkage. The two arms 16 therefore provide the mount which mounts the head 12 to the base 14 such that the head 12 is pivotably moveable relative to the base 14 about a primary axis 15 which is parallel to the pivot axes 24. In this example, the primary axis 15 is a virtual axis (i.e. the axis about which the head 12 pivots is not physically connected to the head 12) due to the four-bar linkage.

In this example, the joints 18 at each head coupling 20 connecting the same arm 16 to the head 12 are spaced apart in a direction parallel to the pivot axes 24 such that they share a pivot axis 24 (i.e. their pivot axes 24 are collinear). The head couplings 20 connecting different arms 16 to the head 12 are spaced apart in a direction perpendicular to the pivot axes 24, such that the joint 18 at head couplings 20 for different arms 16 each permit pivoting movement about different parallel pivot axes 24. The base couplings 22 are also spaced apart along a secondary axis 30. In this example, the secondary axis 30 is perpendicular to the primary axis 15 (and therefore also perpendicular to the pivot axes 24). In other examples, the secondary axis may not be perpendicular to the primary axis, but is not parallel to the primary axis.

In other examples, the pivot axes of all of the joints at the head couplings are collinear, so that the head no longer forms a bar of the linkage, and such that the arms, head and base form a three-bar linkage. In such examples, the head is pivotable about a head pivot axis which passes through the head couplings. In other words, in that example, the head pivot axis is the primary axis.

Each of the head couplings 20 in this example are linear bearings, and so the joints 18 at each head coupling only permit pivoting movement about the parallel pivot axes 24. Each of the base couplings 22 in this example are ball bearings which are configured to cooperate with a corresponding ball socket 32 on the respective arms 16 to form a ball joint (best shown in FIG. 2). The ball joints individually permit pivoting movement about three perpendicular pivot axes. However, due to the four-bar linkage, and the ball joints being spaced apart along the secondary axis 30 (i.e. the joints 18 at the base couplings 22 in this example), the ball joints together are constrained to permit pivoting movement about only their respective pivot axes 24, and the secondary axis 30, which passes through both base couplings 22. The ball joints therefore permit pivoting movement of the arms 16, and thereby the whole four-bar linkage in unison, about the secondary axis 30, such that the pivot axes 24 also pivot about the secondary axis 30.

It will be appreciated that in other examples, the ball bearings may be disposed on the head and the linear bearings may be disposed on the base, such that the four-bar linkage cannot move in unison about the secondary axis relative to the base, but the head may move about a secondary axis passing through the ball bearings relative to the arms and the base.

The mounting assembly 10 comprises a stroke limiter 26 which is configured to obstruct pivoting movement of the head 12 relative to the base 14 beyond a limit. In this example, the stroke limiter 26 is configured to obstruct pivoting movement of the four-bar linkage to inhibit pivoting movement of the head 12 relative to the base 14 about the primary axis 15. In other examples, when the linkage is a three-bar linkage, the stroke limiter may merely limit pivoting movement of the head about the head pivot axis passing through the head couplings.

The stroke limiter 26 in this example comprises a tab protruding from the head 12 in a direction towards the base 14, such that the tab is disposed between the pair of arms 16. The tab is arranged to engage with each of the arms 16 at a respective limit to obstruct movement of the four-bar linkage, to thereby obstruct pivoting movement of the head 12 about the primary axis 15. FIG. 1 shows the tab engaged with one of the arms 16 at a limit. The four-bar linkage is therefore constrained to move between limits imposed by the stroke limiter 26 engaging with each arm 16.

It will be appreciated that the tab may be disposed on the head outside the arms and may be configured to engage the outside of one of the arms to obstruct movement of the four-bar linkage beyond a limit. In other examples, the tab may be disposed on one of the arms, on the base or on the head, and may be configured to engage with the head, the base or the arms, to obstruct pivoting movement of the four-bar linkage or pivoting movement of the head about either the primary axis or the secondary axis. The stroke limiter may only obstruct pivoting movement of the head in one direction (clockwise or anticlockwise about the primary axis or the secondary axis), or may obstruct pivoting movement of the head in both pivoting directions (clockwise and anti-clockwise about the primary axis or the secondary axis).

The mounting assembly 10 further comprises a first biasing element 34a and a second biasing element 34b (only the first biasing element 34a can be seen in FIG. 1). The first biasing element 34a and the second biasing element 34b act independently of one another to provide independent biasing forces. In this example, the first biasing element 34a and the second biasing element 34b are attached to the base 14 and are each configured to engage with one of the arms 16 (i.e. the mount) at a respective first biasing point 40a and second biasing point 40b. In other examples, the biasing elements may be mounted to the head and act on the mount or may be mounted on the base and act directly on the head.

In this example, each biasing element 34 comprises a leaf spring which abuts a respective inner protrusion 36 on one of the arms 16 to push the protrusion 36 upwards (i.e. away from the base 14), thereby providing a biasing force on the arms 16 in a force direction 52. In other examples, the biasing elements may comprise any suitable feature which can provide a suitable biasing force. The force direction 52 at the first biasing point 40a is parallel and in the same direction as the force direction 52 at the second biasing point 40b. In other examples, the force directions may not be parallel and may not be in the same direction.

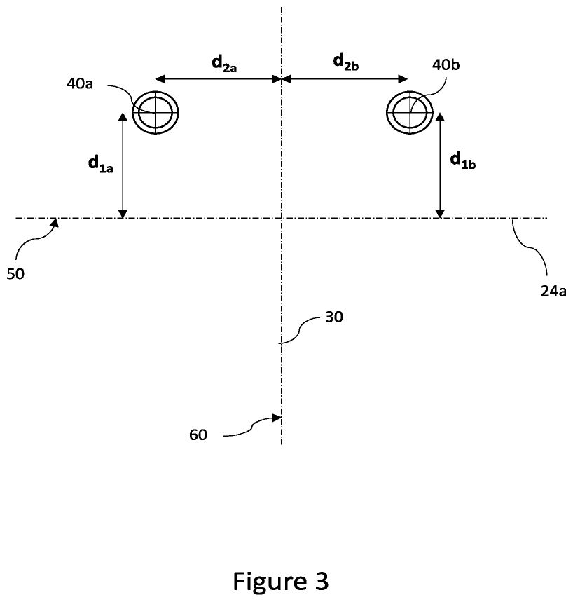

The positioning of the first biasing element 34a and the second biasing element 34b are shown on FIGS. 2 and 3, where FIG. 3 shows the positions in the form of an abstract diagram. In this example, the inner protrusions 36 are positioned on the same arm 16 such that the first biasing element 34a and the second biasing element 34b act on different diverging strands of the same arm 16. Therefore, the first biasing point 40a and the second biasing point 40b are located on the same side of a primary plane 50 (shown in FIG. 3 going into the page), which is defined by a plane comprising a biasing axis 24a and a line parallel to the force direction 52 of the biasing force applied at the first biasing point 40a and the second biasing point 40b (which is coming out of the page in FIG. 3). The biasing axis 24a in this example is the pivot axis 24 which connects the arm 16 having the protrusions 36 to the base 14. The biasing force provided by the first biasing element 34a therefore creates a moment about the biasing axis 24a in the same direction as a moment about the biasing axis 24a provided by a biasing force of the second biasing element 34b. In this example, a moment arm d₁ₐ of the biasing force provided by the first biasing element 34a at the first biasing point 40a from the biasing axis 24a is the same length as a moment arm d_{1b} of the biasing force of the second biasing element 34b at the second biasing point 40b from the biasing axis 24a, such that the first biasing point 40a and the second biasing point 40b lie equidistant from the biasing axis 24a. The moments about the biasing axis 24a provided by the first biasing element 34a and the second biasing element 34b therefore combine to bias the four-bar linkage so as to bias the head 12 about the primary axis 15. The head 12 is biased about the primary axis 15 to a stable position, which is this example is at the limit at which the arm 16 abuts the stroke limiter 26. In other examples, the stable position may be when the biasing elements abut a stop (described in more detail below), or in an example without a stroke limiter, the stable position may be an equilibrium position of the biasing elements, where the biasing elements may be attached to the mount.

In other examples, in which the biasing elements are mounted at any fixed point, such as on the head, on the base, or on the arms, the biasing axis may be any axis about which the first biasing point and the second biasing point are constrained to pivot relative to the fixed point. For example, the biasing elements may be mounted on the base and may be configured to act directly on the head, in which case the biasing axis is the primary axis. In yet further examples, if the joints connecting the head and the arms are ball joints, and if the biasing elements are mounted at a fixed point to a first arm and configured to act on the head, the biasing axis is the pivot axis connecting the first arm and the head.

The first biasing point 40a and the second biasing point 40b are located on opposing sides of a secondary plane 60 which comprises the secondary axis 30 and the line parallel to the force directions 52 applied at the first biasing point 40a and the second biasing point 40b. Therefore, the biasing force applied at the first biasing point 40a creates a moment about the secondary axis 30 which opposes a moment created about the secondary axis 30 by the biasing force applied at the second biasing point 40b. In this example, a moment arm d₂ₐ of the first biasing point 40a from the secondary axis 30 is the same length as a moment arm d_{2b} of the second biasing point 40b from the secondary axis 30, such that the first biasing point 40a and the second biasing point 40b lie equidistant from the secondary axis 30. The biasing forces from the first biasing element 34a and the second biasing element 34b in this example are the same size in the stable position, such that the moments about the secondary axis 30 are equal and opposite to balance the head 12 in the stable position with respect to the base 14 about the secondary axis 30. In other examples, the moment arms of the first biasing point and the second biasing point may be different lengths from the primary axis and the secondary axis. The moment arms of the biasing elements can be used to fine-tune the stiffness in pivoting movement of the head 12 about the primary axis 15 and the secondary axis 30.

As described above, the biasing elements 34 act on the mount in this example to bias pivoting movement of the head 12 with respect to the base 14 about the primary axis 15 and about the secondary axis 30. Due to the arrangement of the biasing points 40 with respect to the primary plane 50 and the secondary plane 60, no further biasing elements are required to achieve a stable position of the head 12 about both the primary axis 15 and the secondary axis 30.

Although it has been described that the force directions 52 applied at the biasing points 40 are parallel, in examples where they are not be parallel, the primary plane may be defined by a plane comprising the primary axis and a line parallel to either one of the force directions. In yet other examples, the force directions may be opposing, such that the moments applied at the first biasing point and the second biasing point are opposing about the primary axis, and are in the same direction about the secondary axis.

Referring back to FIG. 2, the first biasing element 34a and the second biasing element 34b also each comprise a stop 38 which is configured to abut the respective biasing element 34a, 34b to limit its movement in one direction. Such limitation of movement applies a pretension to the biasing elements 34. The pretension can also be adjusted to fine-tune the stiffness of the pivoting movement of the head.

In this example, the first biasing element 34a and the second biasing element 34b, in form of a leaf spring, are disposed on a single integral biasing unit, and each stop 38 is integral with the respective biasing elements 34. Having a single unit which comprises the necessary biasing elements to bias the head about two different axes simplifies construction of the mounting assembly 10 and improves precision in the relative positions of the first biasing point 40a and the second biasing point 40b. Further, having an integral stop 38 with the leaf springs improves tolerances of pretension, which is defined by the part geometry rather than the assembly accuracy. Further, having the stop 38 to introduce pretension also ensures that the force required to move the head from the stable position is higher, thereby improving the stability of the head at the stable position, and minimising vibration.

Although it has been described that the first biasing point 40a and the second biasing point 40b are on different strands of the same arm 16, in other examples, they may be on different arms, on the same side of the secondary plane and on opposing sides of the primary plane such that the moments applied at the first biasing point and the second biasing point are opposing about the primary axis, and are in the same direction about the secondary axis.

Although it has been described that the mount comprises two arms mounted by means of ball bearings and linear bearings, it will be appreciated that in other examples, there may be any suitable mount by which the head is mounted to the base such that the head is pivotably moveable relative to the base about a primary axis and a secondary axis, wherein the primary axis and the secondary axis are not parallel.

Although the application of the biasing elements 34 has been described above with reference to a hair cutting appliance having the mounting assembly 10 with a single head 12, it will be appreciated that the arrangement of biasing elements can be applied to a hair cutting appliance having any number of heads arranged together, such as a rotary hair cutting appliance with two or more heads, and the arrangement of biasing elements can be applied to each head independently.

Variations to the disclosed embodiments can be understood and effected by those skilled in the art in practicing the principles and techniques described herein, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored or distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A mounting assembly for a hair cutting appliance, the mounting assembly comprising:
a head for receiving a cutting unit;
a base and a mount, wherein the head is mounted to the base via the mount such that the head is pivotably moveable relative to the base about a primary axis and a secondary axis, wherein the primary axis and the secondary axis are not parallel; and
a first biasing element and a second biasing element, wherein the first biasing element and the second biasing element act independently of one another,
wherein the first biasing element and the second biasing element are mounted at a fixed point and configured to act on the head or the mount at a respective first biasing point and second biasing point to bias the pivoting movement of the head with respect to the base to a stable position,
wherein the first biasing point and the second biasing point are located on the same side of a primary plane which comprises a biasing axis, parallel to the primary axis, about which the first biasing point and the second biasing point are constrained to pivot relative to the fixed point, and a line parallel to a force direction defined by a biasing force applied at one of the first biasing point or the second biasing point, to bias the head in one pivoting direction to the stable position with respect to the base about the primary axis, and
wherein the first biasing point and the second biasing point are located on opposing sides of a secondary plane which comprises the secondary axis and a line parallel to the force direction, to balance the head in the stable position with respect to the base about the secondary axis.

2. A mounting assembly according to claim 1, wherein the moment arm of the first biasing point from the biasing axis is the same length as the moment arm of the second biasing point from the biasing axis.

3. A mounting assembly according to claim 1, wherein the moment arm of the first biasing point from the secondary axis is the same length as the moment arm of the second biasing point from the secondary axis.

4. A mounting assembly according to claim 1, wherein the mount comprises two arms disposed between the base and the head to form a linkage, each arm being coupled at a joint to a respective head coupling on the head, and coupled at a joint to a respective base coupling on the base, each joint at each head coupling configured to permit pivoting movement about respective parallel head pivot axes, such that the head is pivotable relative to the base about one of the primary axis and the secondary axis;
wherein the joints at the base couplings are configured to permit pivoting movement of the arms about at least the other of the primary axis and the secondary axis.

5. A mounting assembly according to claim 4, wherein the joints at the base couplings further permit pivoting movement about respective base pivot axes which are parallel to the head pivot axes, wherein each arm is coupled to a different respective head coupling to permit pivoting movement about different parallel head pivot axes, thereby forming a four-bar linkage, by which the head is pivotably moveable relative to the base about a virtual pivot axis which is one of the primary axis or the secondary axis.

6. A mounting assembly according to claim 5, wherein the virtual pivot axis is the primary axis.

7. A mounting assembly according to claim 1, comprising a stroke limiter which is configured to obstruct pivoting movement of the head relative to the base beyond a limit.

8. A mounting assembly according to claim 7, wherein the stroke limiter is configured to obstruct pivoting movement of the four-bar linkage to thereby inhibit pivoting movement of the head relative to the base about the primary axis beyond the limit, wherein the biasing force at the first biasing point and the second biasing point have the same moment direction about the biasing axis.

9. A mounting assembly according to claim 7, wherein the stable position is the limit.

10. A mounting assembly according to claim 1, wherein each biasing element is a leaf spring.

11. A mounting assembly according to claim 1, wherein each biasing element is disposed on a single integral biasing unit.

12. A mounting assembly according to claim 1, comprising a stop for each biasing element which is configured to abut the respective biasing element to limit movement of the biasing element to thereby pretension the biasing element.

13. A mounting assembly according to claim 12, wherein the stop is integral with the biasing element.

14. A hair cutting appliance comprising a mounting assembly according to claim 1.
